(19) United States
(12) Patent Application Publication
(10) Pub. No.: US 2010/0158636 A1
(43) Pub. Date: Jun. 24, 2010

(54) TACK SET FOR USE ON BULLETIN BOARDS

(76) Inventor: Sung Jin Park, Seoul (KR)

Correspondence Address: SHERR & VAUGHN, PLLC, 620 HERNDON PARKWAY, SUITE 320, HERNDON, VA, 20170, US

(21) Appl. No.: 11/916,045

(22) PCT Filed: Jun. 30, 2005
(86) PCT No.: PCT/KR2005/002063

§ 371 Date: Mar. 5, 2010

(30) Foreign Application Priority Data
May 27, 2005 (KR) 10-2005-0044924
May 27, 2005 (KR) 10-2005-0044927

(51) Int. Cl. B43M 15/00; F16B 15/00

(52) U.S. Cl. 411/457

(57) ABSTRACT

A tack set to fix items to be posted is disclosed. The tack set is configured as a first embodiment wherein a fixing pin having a coupling part and a wire formed with a loop and coupled with the coupling part in order to be connected to the fixing pin are formed, or a connection member is not integral with the fixing pin but is formed with push-pin rings on both ends thereof, through which the pin of a conventional push-pin may be inserted and removed, thereby being capable of attaching or detaching items to be posted with a fixing pin or a conventional insertion pin, and a second embodiment having an improved shape and structure of the tack set, capable of facilitating fixation or removal of items to be posted with the fixing pin through a rectangular-shaped thin plate having coupling parts shaped with continuous convex and concave portions and fixing pins formed on predetermined opposite positions of the thin plate, to fix the items to be posted.

### TECHNICAL FIELD

The present invention relates, in general, to a tack set used to fix notices or memos to be posted (“item to be posted”) on a bulletin board and, more particularly, to a tack set to fix items to be posted, configured as a first embodiment wherein a fixing pin having a coupling part and a wire formed with a loop and coupled with the coupling part in order to be connected to the fixing pin are formed, or a connection member is not integral with the fixing pin but is formed with push-pin rings on both ends thereof, through which the pin of a conventional push-pin may be inserted and removed, thereby being capable of attaching or detaching items to be posted with a fixing pin or a conventional insertion pin, and a second embodiment having an improved shape and structure of the tack set, capable of facilitating fixation or removal of items to be posted with the fixing pin through a rectangular-shaped thin plate having coupling parts shaped with continuous convex and concave portions and fixing pins formed on predetermined opposite positions of the thin plate, to fix the items to be posted.

### BACKGROUND ART

As known to the general public, a conventional fixing pin is commonly called a “push-pin,” wherein a straight insertion pin, pointed at the end, is fixedly attached to a lower part of a disc-shaped main body of the push-pin.

However, a fingernail, or a separate tool must be used to remove this conventional push-pin, thereby causing inconvenience in the removal of the push-pin.

When a conventional push-pin is pressed into a bulletin board, since an item to be posted is supported only by the straight insertion pin, the item to be posted easily becomes detached from the bulletin board by even a small external force. Further, since the push-pin is generally very small in size, it is difficult to locate the push-pin if lost. Thus, if the straight insertion pin is inverted so that the pointed end is directed upwards, this hurts a user's body if the user steps on the inverted push-pin, thereby generating a problem in terms of a user's safety.

### DETAILED DESCRIPTION OF INVENTION

Features and advantages of the present invention will be more apparent by the detailed description of the invention with reference to the accompanying drawings. Prior to this, based on the principle that terms or words used throughout the specification and drawings may properly define concepts describing an inventor's own invention, they should be interpreted in the context of meanings and concepts pertaining to the technical idea of the present invention.

An object of the present invention is to provide a tack set capable of being used to more firmly fix an item to be posted and easily remove it.

Another object of the present invention is to provide a tack connection member to connect two tacks, comprising push-pin rings on both ends of the connection member, through which insertion pins of conventional push-pins are inserted and removed, thereby being capable of having conventional push-pins inserted into the push-pin rings.

A further object of the present invention is to provide a tack set for fixation of an item to be posted, having an improved shape and structure thereof, capable of facilitating fixation and removal of the item to be posted through a rectangular-shaped thin plate and fixing pins formed at predetermined positions on the thin plate.

In order to accomplish the above objects, the present invention provides a tack set to fix items to be posted, configured as a first embodiment wherein a fixing pin having a coupling part and a wire formed with a loop and coupled with the coupling part in order to be connected to the fixing pin are formed, or a connection member is not integral with the fixing pin but is formed with push-pin rings on both ends thereof, through which the pin of a conventional push-pin may be inserted and removed, thereby being capable of attaching or detaching items to be posted with a fixing pin or a conventional insertion pin, and a second embodiment having an improved shape and structure of the tack set, capable of facilitating fixation or removal of items to be posted with the fixing pin through a rectangular-shaped thin plate having coupling parts shaped with continuous convex and concave portions and fixing pins formed on predetermined opposite positions of the thin plate, to fix the items to be posted.

### DESCRIPTION OF DRAWINGS

FIG. 1 is a perspective view of a tack set for fixation of an item to be posted according to the first embodiment of the present invention;

FIGS. 2 and 3 are respectively a rear view of a tack coupling part having a concave lower surface in the tack set according to the first embodiment of the present invention, and a side sectional view taken along line A-A′ of FIG. 2;

FIG. 4 is a front view of the tack set for fixation of an item to be posted according to the first embodiment of the present invention;

FIG. 5 is a perspective view illustrating use of the tack set for fixation of the item to be posted, by inserting a finger into a finger handle according to the first embodiment of the present invention;

FIGS. 6 and 7 are a front view and a side view illustrating fixation of an item to be posted by use of the tack set for fixation of the item to be posted according to the first embodiment of the present invention;

FIG. 8 is a perspective view of a connection member having rings additionally formed on both ends thereof, for fixation of an item to be posted according to the first embodiment of the present invention;

FIG. 9 is a perspective view of a tack set for fixation of an item to be posted according to a second embodiment of the present invention;

FIG. 10 is a front view of the tack set for fixation of the item to be posted according to the second embodiment of the present invention;

FIG. 11 is a perspective view illustrating use by a user of the tack set for fixation of the item to be posted according to the second embodiment of the present invention; and

FIG. 12 is a front view illustrating fixation by the tack set of the item to be posted on a bulletin board according to the second embodiment of the present invention.

### DESCRIPTION OF THE REFERENCE NUMERALS USED IN THE DRAWINGS

10, 60: Tacks 20: Connection member
71: End coupling parts
72: Central coupling part
30: Memo 40, 80: Items to be posted

### Best Mode for Carrying Out the Invention

Embodiments of the present invention will be described in detail with reference to the illustrative drawings.

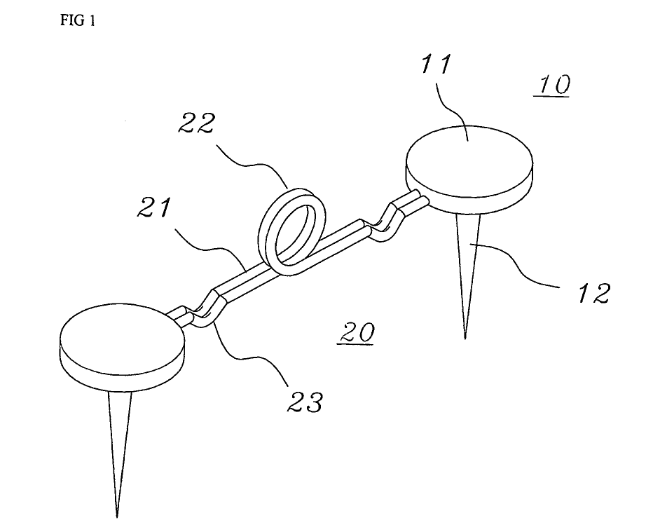

FIG. 1 is a perspective view illustrating a tack set for fixation of an item to be posted (hereinafter, referred to simply as “the tack set”) according to a first embodiment of the present invention.

The tack set is formed with a loop 22 produced by bending a wire 21 such that the loop 22 is perpendicular to a longitudinal axis of the wire 22, and tacks 10 being coupled with both ends of the wire 21.

In this tack set, it is preferred that the wire be made of an elastic material, or that both ends thereof be coupled with the tacks under the condition that they are angled downwards by a predetermined angle based on the horizon.

When fixing an item to be posted, the tack set according to the present invention is capable of fixing the item to be posted with less force thanks to the elastic recovery force generated in the direction of a fixing pin 12 of the tack, due to use of the wire made of an elastic material or both ends of which are angled downwards, and is capable of more firmly fixing the item to be posted because of the wire 21 further comprising a circular loop 22 and protrusions 23 formed downwards between both ends of the wire 21.

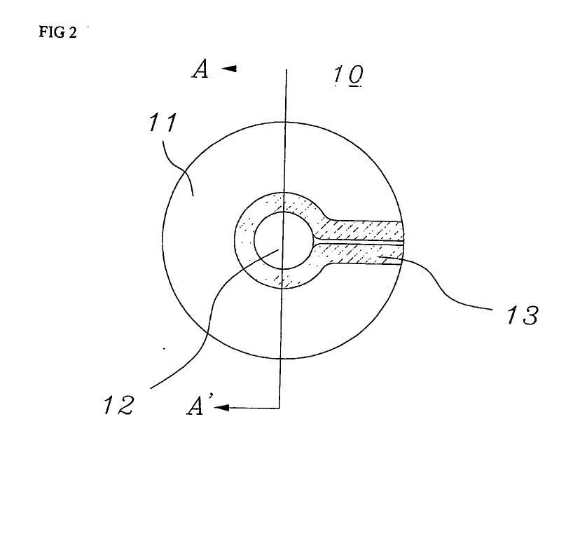

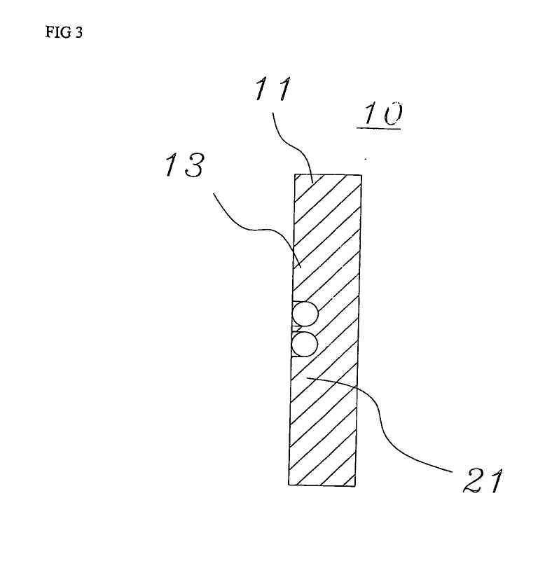

FIGS. 2 and 3 are, respectively, a rear view of a tack coupling part 11 having a concave lower surface 13 in the tack set according to the first embodiment of the present invention, and a side sectional view taken along line A-A′ of FIG. 2.

As illustrated, the wire 21 and the tack 10 are combined so as to form a loop surrounding the fixing pin 12 of the tack by allowing the wire to be inserted into the concave lower surface 13 formed on the tack coupling part 11.

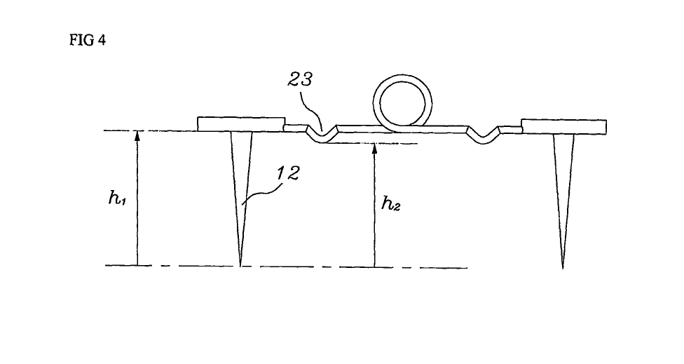

FIG. 4 is a front view of the tack set according to the first embodiment of the present invention.

As described above, since protrusions 23 are formed on the wire, the heights (h₂) of the lowest points of the protrusions are lower than the heights of the fixing pins (h₁), based on the ends of the fixing pins 12 of the tacks.

When an item to be posted is fixed using the tack set formed of a wire with the shape and the material described above, since upward displacement equal to the difference (h₁−h₂) between the lowest height (h₁) of the protrusion and the height (h₂) of the fixing pin is generated, the elastic recovery force is generated inside the wire, whereby the protrusions 23 serve to press and more firmly fix the item to be posted.

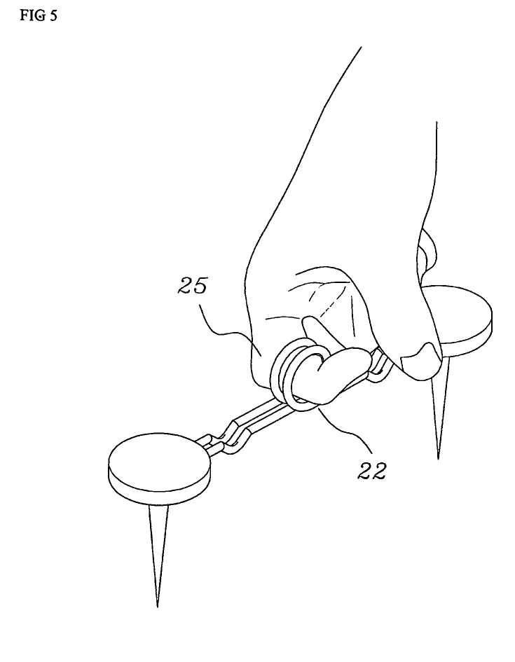

FIG. 5 is a perspective view illustrating use of the tack set for fixation of the item to be posted, by inserting a finger 25 into a loop 22 of the tack set according to the first embodiment of the present invention. This figure illustrates the use of the loop provided to solve the problem encountered when removing a tack.

As illustrated, it is easy to carry the tack set or remove it from the bulletin board by inserting a finger into the loop 22 of the tack set.

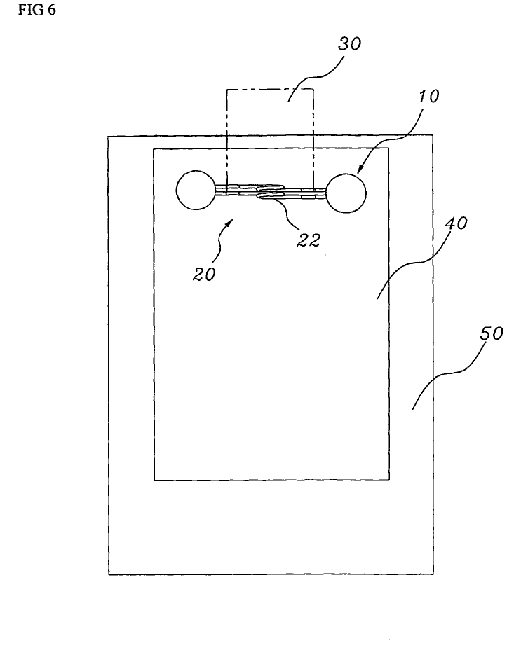

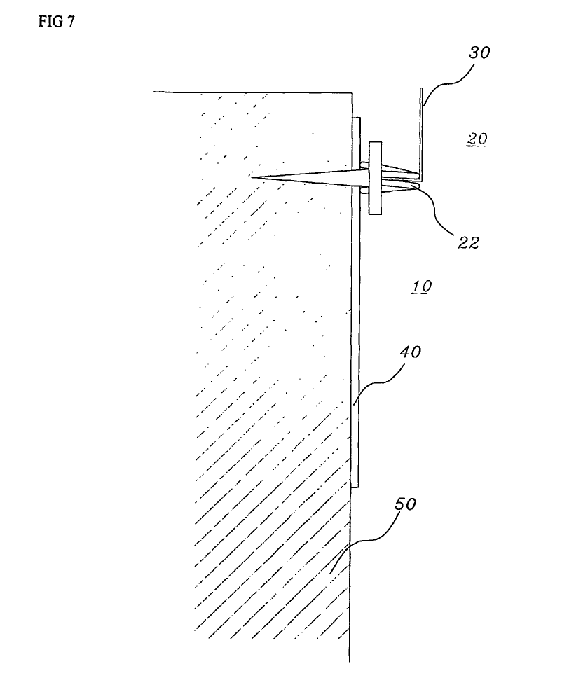

FIGS. 6 and 7 are a front view and a side view illustrating fixation of an item to be posted using the tack set for fixation of an item 40 to be posted according to the first embodiment of the present invention.

The tack set fixed with the item to be posted has a plurality of wires 21 as a connection member to connect the tacks 10, and thus, a memo 30 may be inserted between the wires 21 forming the loop 22 and closely contacting each other. The memo may be used to display titles or a summary of the item to be posted.

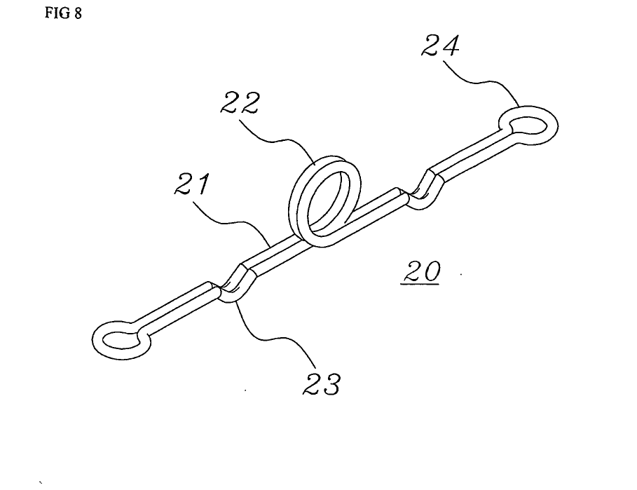

FIG. 8 is a perspective view of a connection member 20 having push-pin rings 24 additionally formed on both ends thereof, for fixation of an item to be posted according to the first embodiment of the present invention.

Since the push-pin rings 24, through which the insertion pins of conventional push-pins are inserted and removed, are formed on both ends of the connection member 20, the connection member may not be integrally formed with the tack 10, and may be used independently from the tack 10.

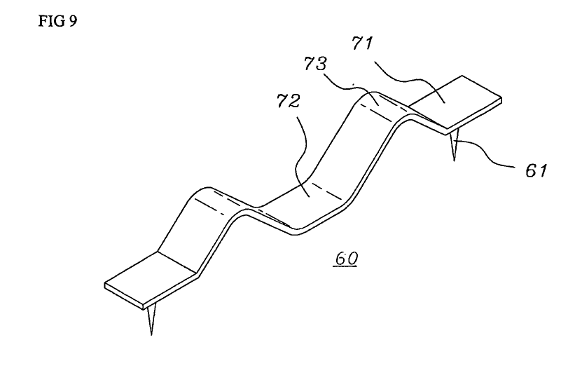

FIG. 9 is a perspective view of the tack set for fixation of an item to be posted (hereinafter referred to as “the tack set”) according to the second embodiment of the present invention.

As illustrated in FIG. 9, the tack set according to the second embodiment of the present invention comprises a rectangular-shaped thin plate 60 and fixing pins 61 vertically attached to the lower surfaces of both ends of the thin plate 60.

The thin plate 60 comprises end coupling parts 71 on both ends thereof, on the lower surfaces of which fixing pins are mounted, a central coupling part in the center thereof, parallel to the end coupling parts and positioned lower than them, and convex-shaped bent parts 73 positioned between the end coupling parts 71 and the central coupling part 72 and directed upward. The bent parts 73 are preferably formed to have a round shape so that a user can easily insert and remove his/her finger as necessary.

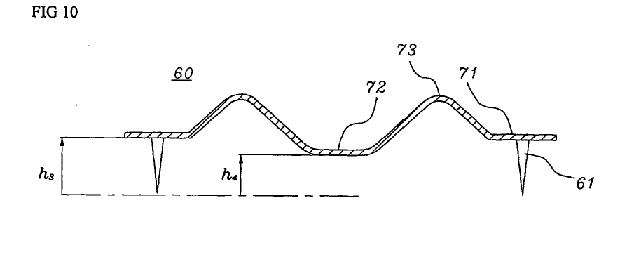

FIG. 10 is a front view of the tack set for fixation of an item to be posted according to the second embodiment of the present invention.

As described above, the thin plate 60 is formed so that the height (h4) of the lower surface of the central coupling part 72 is lower than the heights (h1) of the end coupling parts 71, based on the lower end of the fixing pin 61 of the tack set.

The thin plate is desirably manufactured from an elastic material, to push the item to be posted with the elastic force thereof.

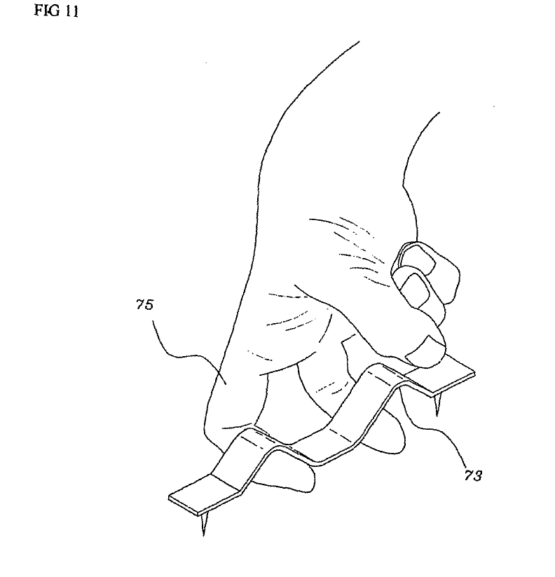

When an item to be posted is fixed using the tack set formed of the thin plate with the shape and the material described above, since upward displacement equal to the difference (h3−h4) between the central coupling part and the end coupling parts is generated, the elastic recovery force is accordingly generated inside the thin plate, whereby the central coupling part 72 serves to press and more firmly fix the item to be posted (80 of FIG. 11).

FIG. 11 is a perspective view illustrating use by a user of the tack set for fixation of the item to be posted according to the second embodiment of the present invention.

As described above, since bent parts 73 directed upward are formed between the end coupling parts 71 and the central coupling part 72, a user can easily fix and remove the tack set to and from the bulletin board, by inserting his/her fingers 75 into spaces formed by the bent parts 73.

The bents parts of the tack set are desirably rounded so that the user can easily use it by inserting his/her fingers thereinto.

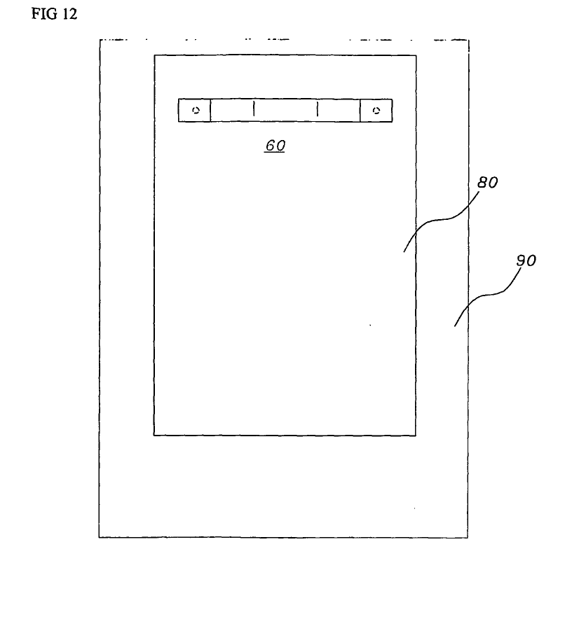

FIG. 12 is a front view illustrating fixation by the tack set of an item to be posted on a bulletin board 90 according to the second embodiment of the present invention.

As illustrated, the user disposes an item 80 to be posted on any desired position of the bulletin board 90, and fixes the item at the desired position by use of the tack set according to the present invention.

Although the preferred embodiments of the present invention have been disclosed for illustrative purposes, the present invention shall not be limited to constructions and operations illustrated and described above. Rather, those skilled in the art will appreciate that various modifications, additions and substitutions are possible, without departing from the scope and spirit of the invention as disclosed in the accompanying claims. Accordingly, all the appropriate modifications and amendments, and any equivalents thereto shall be regarded as falling under the scope of the present invention.

### INDUSTRIAL APPLICABILITY

According to the present invention as described above, an item to be posted may be easily fixed to or removed from a bulletin board by means of the tack set for fixation of the item to be posted, wherein fixing pins are interconnected by a connection member formed with a loop, or the tack set having a connection member comprising a rectangular-shaped thin plate having a coupling part in the center, coupling parts on both ends on which fixing pins are mounted, and an upward bent part.

In the tack set of the present invention, the wire used as a connection member further comprises downward protrusions whereby the item to be posted is further pressed and fixed together with fixing pins coupled with the wire when the item to be posted is fixed onto the bulletin board, or a thin plate is formed to have different heights between the central coupling part and the end coupling parts, whereby the central coupling part provides additional pressing and fixing force along with the fixing pins coupled with the end coupling parts, and thus, the item to be posted can be more firmly fixed compared to fixation of the item to be posted using conventional push-pins.

Further, the connection member to connect tacks further comprises push-pin rings on both ends thereof, through which conventional push-pins are inserted and removed, thereby easily fixing and removing the item to be posted to and from the bulletin board by inserting an insertion pin of the conventional push-pin into the push-pin ring.

In addition, since the tack set of the present invention is bigger than the conventional push-pin since a connection member made of a wire or a thin plate is integrally formed with a fixing pin, it can be easily found when lost, thereby preventing an accident endangering a user's safety from occurring when the lost push-pin is not found.

1. A tack set for fixing an item to be posted, comprising:
two tacks (10); and a connection member (20) interconnecting the two tacks (10),
wherein the two tacks (10) each comprise a coupling part (11) and a fixing pin (12), and the connection member (20) is manufactured from a plurality of wires (21) having predetermined elasticity, wherein the wires (21) surround the fixing pins (12) of the two tacks to form a loop, and extend in parallel between the two tacks, a loop (22) into which a finger is inserted is provided in the center of each of the wires (21), a protrusion (23) to press the item to be posted is formed between each of the two tacks and the loop, and a groove (13) into which the wire is embedded is formed on the coupling part of each of the tacks, thereby pressing the bulletin board.

2. The tack set for fixing the item to be posted according to claim 1, wherein the loops (22) formed on the plurality of wires (21) are in contact with each other, thus allowing a memo (30) to be inserted between the loops.

3. A tack set for fixing an item to be posted, comprising:
two tacks (10); and a connection member (20) interconnecting the two tacks (10),
wherein the connection member (20) is manufactured from a plurality of parallel wires (21) having predetermined elasticity, the parallel wires (21) are formed between the two tacks (10), loops (22) into which a finger is inserted are formed in the centers of the plurality of wires (21), a protrusion (23) to press the item to be posted is formed between each of the tacks and the loops, and push-pin rings (24) through which insertion pins of the tacks (10) are inserted and removed are formed on both ends of the plurality of wires 21.

4. A tack set for fixing an item to be posted, comprising:
a rectangular-shaped thin plate (60); and fixing pins (61) formed on predetermined positions of both ends of the thin plate (60),
wherein the thin plate (60) comprises coupling parts on both ends thereof to fix the item to be posted when the fixing pins (61) are pushed; and a coupling part (72) in the center thereof, wherein the fixing pins are mounted on both end coupling parts (71) positioned on both, ends of the thin plate, the central coupling part (72) formed in the center of the thin plate is positioned lower than both end coupling parts (71), both end coupling parts (71) and the central coupling part (72) are parallel to each other, and bent parts (73) directed upwards are formed between both end coupling parts (71) and the central coupling part (72).

5. The tack set for fixing the item to be posted according to claim 4, wherein the bent parts (73), directed upwards between both end coupling parts (71) and the central coupling part (72), are rounded so as to allow a user to remove the tack set by inserting fingers into the bent parts (73).
